(19) United States
(12) Patent Application Publication
(10) Pub. No.: US 2014/0131986 A1
(43) Pub. Date: May 15, 2014

(54) Support Device for Commercial Vehicles

(71) Applicant: Reinhold Riedl, Miltenberg (DE)

(72) Inventor: Reinhold Riedl, Miltenberg (DE)

(73) Assignee: SAF-HOLLAND GmbH

(21) Appl. No.: 14/128,349

(22) PCT Filed: Jun. 1, 2012
(86) PCT No.: PCT/EP2012/060326

§ 371 Date: Jan. 13, 2014

(30) Foreign Application Priority Data
Jun. 24, 2011 (DE) 10 2011 078 065.3

(51) Int. Cl. B60S 9/08

(52) U.S. Cl. CPC B60S 9/08
USPC 280/763.1

(57) ABSTRACT

A support device for commercial vehicles, that includes a support outer pipe adapted to be fixed to a chassis of the commercial vehicle, and a support inner pipe displaceably mounted in the support outer pipe, wherein the support inner pipe is connected to a nut in engagement with a spindle driven by a gearbox comprising an output shaft, a bevel gear step and a switchable region composed of a low gear wheel and a fast gear pinion that are fixed on the output shaft, a low gear intermediate gear wheel set having a low gear intermediate gear wheel and a low gear intermediate pinion engaged with the low gear wheel, a fast gear wheel engaged with the fast gear pinion, and a low gear pinion engageable with the low gear intermediate gear wheel and the fast gear wheel.

### BACKGROUND OF THE INVENTION

The invention relates to a support device for commercial vehicles, in particular a height-adjustable support for semi-trailers or the like.

Such supports are arranged in pairs at the front end of semi-trailers, and in fast gear may be brought into the support or transport position, and in low gear they may be used to lift the front portion of the semi-trailer in case this becomes necessary during the coupling operation.

A support of the type mentioned is known from DE 198 36 635 C5. In this so-called device for supporting a semi-trailer of a road tractor, the gear wheels are arranged mainly within the support outer pipe. Here, on the gearbox output shaft there is arranged a large-diameter gear wheel which in low gear operation is driven by means of a pinion located on the gearbox input shaft. The gearbox input shaft is located in the same vertical plane as the gearbox output shaft and below the latter. Moreover, concentrically with respect to the gearbox input shaft, there is arranged a further large-diameter gear wheel of the fast gear step. Due to said vertical arrangement of the wheels the gearbox space which is required height-wise both above the gearbox input shaft and below the gearbox output shaft is large.

The object underlying the invention is to propose a support device for commercial vehicles, wherein the support inner pipe or tube may be retracted far into the support outer pipe or tube, and in case the support inner tube is regularly extended, it is ensured that the remaining portion thereof is securely guided in the support outer pipe. Moreover, it should be made possible to build particularly short, i.e. low, support devices having the largest possible travel while achieving large chassis clearance during travel according to the requirements in terms of traffic technology.

### SUMMARY OF THE INVENTION

According to the invention there is provided a support device for commercial vehicles, such as trailers or semi-trailers, comprising a support outer pipe or tube that can be fixed to a chassis of the commercial vehicle, and a support inner pipe or tube that is mounted displaceably in the support outer pipe, wherein the support inner pipe is connected to a nut that is in engagement with a spindle, which can be driven by a gearbox or transmission, wherein the gearbox comprises an output shaft, a bevel gear step and a switchable region, wherein the switchable region is composed of a low gear wheel and a fast gear pinion that are fixed on the output shaft, a low gear intermediate gear wheel set having a low gear intermediate gear wheel and a low gear intermediate pinion that is in engagement with the low gear wheel, a fast gear wheel that is in engagement with the fast gear pinion, and a low gear pinion that can optionally be brought in engagement with the low gear intermediate gear wheel or fast gear wheel, wherein the rotational axes of the low gear intermediate gear wheel set and of the low gear pinion are arranged in different vertical planes and below the rotational axis of the output shaft. In the support according to the invention, there is firstly provided in a known manner a relatively small low gear wheel on the output shaft of the gearbox, which makes the distance between the output shaft and the upper support end advantageously small. This makes it possible to provide a support device in which the construction height of a gearbox located within the support outer pipe is small. The term vertical plane is to be understood to mean that the same lies in the longitudinal direction of the support or in the direction of retracting/extending the support inner pipe into the support outer pipe and parallel to the rotational axis of the output shaft. Accordingly, the horizontal plane is perpendicular to the vertical plane and parallel to the rotational axis of the output shaft. The support inner pipe is suitably retractable and extendable into the support outer pipe in a vertical direction, which lies in the vertical plane. The support inner pipe advantageously is directly connected to the nut —for example by means of welding, bonding or positive and/or frictional locking—or via intermediate elements—such as a screw connection. Expediently, the rotational axes of the low gear intermediate gear wheel set and of the low gear pinion lie below the output shaft. Advantageously, the low gear intermediate pinion is in engagement with the low gear wheel.

If, advantageously, the low gear intermediate gear wheel set and the input shaft or alternatively the pinion coupling part located on the driving piece are not arranged perpendicularly below but reversely displaced laterally below the output shaft, advantageously, there results for the gearbox elements an overall very low construction height requirement in the support outer pipe. This makes it possible that the spindle is shorter in the bearing area and the nut bearing the support inner pipe may far retract. Moreover, as regards outlay, there will be a positive influence on the support pipe with regard to the design of its upper portion.

Advantageously, the rotational axes of the low gear intermediate gear wheel set and of the fast gear wheel are arranged in different vertical planes and below the output shaft.

Preferably, the fast gear wheel and the low gear pinion are arranged on the same rotational axis.

Preferably, the rotational axis of the spindle is located between the rotational axes of the low gear intermediate gear wheel set and of the low gear pinion.

In a preferred embodiment, the rotational axes of the output shaft, of the low gear intermediate gear wheel set, and of the low gear pinion are arranged parallel to each other.

Advantageously, the rotational axes of the low gear intermediate gear wheel set and of the low gear pinion are arranged in different horizontal planes.

Expediently, the rotational axis of the low gear intermediate gear wheel set is arranged in a horizontal plane closer to the rotational axis of the output shaft than the horizontal plane in which lies the rotational axis of the low gear pinion. Preferably, the low gear pinion is fixed to a pinion coupling part, which is preferably supported in a bearing element together with the spindle.

Preferably, there is provided a driving piece or an input shaft designed to exert a rotational force onto the low gear pinion, preferably by engaging the pinion coupling part.

Expediently, there is provided a foot at a distal end portion of the support inner pipe.

Further features and advantages of the invention will be described with the help of exemplary embodiments with reference to the appended Figures.

### BRIEF DESCRIPTION OF THE DRAWINGS

FIG. 1 shows a front view of a preferred embodiment of the support device according to the invention,

FIG. 2 shows a side view of the support device shown in FIG. 1,

FIG. 3 shows a longitudinal section of the support device shown in FIG. 1 along line A-A, and

FIG. 4 shows a longitudinal section of the support device shown in FIG. 2 along line B-B in an alternative design to FIG. 3.

### DETAILED DESCRIPTION OF THE PREFERRED EMBODIMENTS

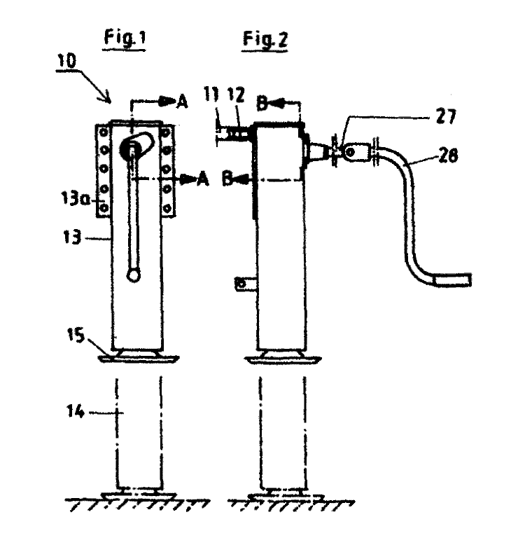

The support or support device 10 shown in FIGS. 1 to 4 is used in pairs on a commercial vehicle such as a semi-trailer and each pair is drivingly connected by means of a connecting shaft 11 between the output shafts 12. In the transport position, the supports are retracted, i.e. in their shortened state. They are extended before the semi-trailer is decoupled from the road tractor. The support 10 comprises a support outer pipe 13 and a support inner tube 14, which is longitudinally movable or displaceable therein. The support outer pipe 13 and the support inner pipe 14 preferably have square cross-sections. The support 10 is fastened to the chassis of the semi-trailer by means of a screw mounting plate 13a located at the support outer pipe 13. At the bottom end of the support inner pipe 14, there is arranged a foot 15 for touching down onto the ground.

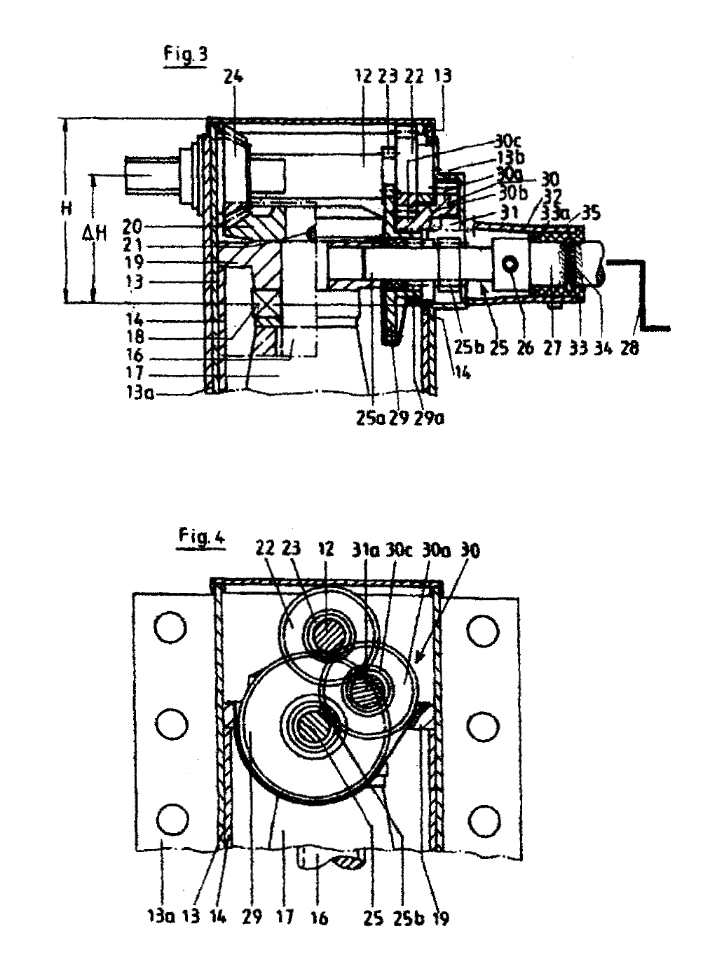

As is shown in FIG. 3, the support 10 comprises a spindle 16 with a nut 17. The nut 17 is connected to the support inner pipe 14 (not shown). On a disc on the shoulder of the spindle 16, there is arranged an axial bearing 18, which is supported on a bearing element or bearing part 19 fastened inside of the support outer pipe 13.

Above the bearing part 19, there is arranged a crown wheel 20, which is non-rotatably connected to the spindle 16 by means of a pin 21 carrying the spindle 16. Above the crown wheel 20, the output shaft 12 is supported in the support outer pipe 13.

In the front area of the output shaft 12, there are non-rotatably arranged a low gear wheel 22 as well as a fast gear pinion 23 and a bevel pinion 24. The tip diameter of the low gear wheel 22 is conceptionally dimensioned small so that from the center of the output shaft 12 to the upper end of the support 10 there is only a small building space share.

In the bearing part 19, the spindle 16 is supported vertically, and an axially slidable pinion coupling part 25 is supported horizontally.

The pinion coupling part 25 is arranged laterally displaced below the output shaft 12 and comprises a bearing pin 25a as well as teeth as low gear pinion 25b. It is connected to a driving piece 27 via a scarf joint by means of a clamping pin 26.

At the outer end of the driving piece 27 there is fastened a swivel-mounted hand crank 28.

The bearing pin 25a, apart from supporting the pinion coupling part 25, also serves for supporting a fast gear wheel 29, which is assigned to the fast gear pinion 23 sitting on the output shaft 12. In the fast gear wheel 29, there are provided coupling teeth 29a. Height-wise between the pinion coupling part 25 and the output shaft 12, there is located in parallel axle arrangement a low gear intermediate gear wheel set 30, which is laterally displaced relative to the output shaft 12. By contrast, the pinion coupling part 25 is arranged mirror-symmetrically to the low gear intermediate gear wheel set 30 laterally from the output shaft 12.

Said height-wise and laterally displaced arrangements lead to a very compact construction of the gearbox within the support inner pipe 14. Here, below the rotational axis of the output shaft 12, the gearbox will have an influence on the partial design of the support inner pipe 14 only in the portion ΔH. Together with the little building space required from the output shaft 12 up to the upper end of the support, the overall building height required for the gearbox corresponds merely to the portion designed by H in the support outer pipe 13.

The low-gear intermediate gear wheel set 30 consists of a low gear intermediate gear wheel 30a with which the teeth of the low gear pinion 25b may interact, a bearing area 30b as well as a low gear intermediate pinion 30c, which engages the low gear wheel 22. Moreover, the low gear intermediate gear wheel set 30 comprises an inner bearing region at the front end.

The low gear intermediate gear wheel set 30 is supported centrally with its bearing area 30b in a partially reinforced wall part at the support outer pipe 13 and at the end with its inner bearing area on a kingpin 31 located at a formed region 13b of the front wall of the support outer pipe 13.

A bearing sleeve 32 attached at the formed portion 13b of the support outer pipe 13 comprises a bearing area provided with a collar bush 33 for the driving piece 27. In the collar bush 33, there are arranged two radial grooves 33a which a ball stop 34 mounted in the driving piece 27 may alternatingly engage.

The gearbox functions of the support 10 are as follows:

For low gear operation the teeth of the low gear pinion 25b are in engagement with the low gear intermediate gear wheel 30a, wherein the ball stop 34 is locked in the driving piece 27 for axially fixing the pinion coupling part 25 in the front radial groove 33a.

As is shown by the arrows in FIG. 3, when the hand crank 28 is rotated, force flows from the driving piece 27 at first into the pinion coupling part 25 and from there via the teeth of the low gear pinion 25b on to the low gear intermediate gear wheel 30a of the low gear intermediate gear wheel set 30. The low gear intermediate pinion 30c transmits the force onto the low gear wheel 22 and thus into the output shaft 12. The flow of force then branches into a first part, which is introduced into the spindle 16 via the bevel pinion 24 and the crown wheel 20 so as to move the nut 17 with the support inner pipe 14 attached thereto, and a second part which is provided at the journal of the output shaft 12 for transmission via the connecting shaft 11 for driving the neighboring support.

During fast gear operation the pinion coupling part 25 is moved in the direction towards the center of the support 10 (not shown) so that the teeth of the low gear pinion 25b with their front area dip into the full depth of the coupling teeth 29a of the fast gear wheel 29, so that there is provided a positive-fit coupling of the pinion coupling part 25 and the fast gear wheel 29. The ball stop 34 is here locked in the rear radial groove 33a.

Between the shift position of the pinion coupling part 25 for low gear and that for fast gear a free shifting is possible in which the teeth of the low gear pinion 25b are not engaged. During shifting, if necessary, due to said free shifting, by means of a small idling movement, the pinion coupling part 25 may easily be made to engage the coupling teeth 29a of the fast gear wheel 29 or the teeth of the low gear intermediate gear wheel 30a.

Expediently, there is thus provided a height-adjustable support 10 for semi-trailers or the like, comprising a support outer pipe 13 to be attached to the chassis of the semi-trailer, a support inner pipe 14 arranged slidably or displaceably in the support outer pipe 13, at the bottom end portion of which a foot 15 is attached and which is connected to a nut 17 arranged on a spindle 16 which comprises a gearbox with at least one bevel gear stage 24, 20 and upstream thereof a switchable region with a fast gear wheel 29 and a fast gear pinion 23 as well as a low gear pinion 25b with a low gear wheel 30a, as well as a low gear intermediate gear wheel set 30, wherein a pinion coupling part 25 arranged at a driving piece 27 or an input shaft together with the spindle 16 are supported in a bearing part 19, wherein the rotational axis of the intermediate gear wheel set 30 and the rotational axis of the driving piece 27 and of the pinion coupling part 25 or of the input shaft are arranged below the output shaft 12 in different vertical planes, which are located laterally of the axis of the spindle 16. Advantageously, the bevel pinion 24 is arranged at the rear of the support outer pipe 13.

### LIST OF REFERENCE SIGNS

10 support
11 connecting shaft
12 output shaft
13 support outer pipe
13a screw mounting plate
13b formed portion
14 support inner pipe
15 foot
16 spindle
17 nut
18 axial bearing
19 bearing part
20 crown wheel
21 pin
21 low-gear wheel
22 fast-gear pinion
23 bevel pinion
25 pinion bearing part
25a bearing pin
25b teeth of the low gear pinion
27 driving piece
28 hand crank
29 fast-gear wheel
29a coupling teeth
30 low gear intermediate gear wheel set
30a low gear intermediate gear wheel
30b bearing area
30c low gear intermediate pinion
31 kingpin
32 bearing sleeve
33 collar bush
33a radial groove
34 ball stop

1.-10. (canceled)

11. A support device for commercial vehicles, comprising:
a support outer pipe adapted to be fixed to a chassis of a commercial vehicle;
a support inner pipe mounted displaceably in the support outer pipe;
wherein the support inner pipe is connected to a nut that is in engagement with a spindle, which is adapted to be driven by a gearbox;
wherein the gearbox comprises an output shaft, a bevel gear step and a switchable region;
wherein the switchable region comprises:
a low gear wheel and a fast gear pinion that are fixed on the output shaft;
a low gear intermediate gear wheel set having a low gear intermediate gear wheel and a low gear intermediate pinion that is in engagement with the low gear wheel;
a fast gear wheel that is in engagement with the fast gear pinion; and
a low gear pinion engageable with the low gear intermediate gear wheel and the fast gear wheel, wherein a rotational axis of the low gear intermediate gear wheel set and a rotational axis of the low gear pinion are arranged in different vertical planes and below a rotational axis of the output shaft.

12. The support device of claim 11, wherein the rotational axis of the low gear intermediate gear wheel set and the rotational axis of the fast gear wheel lie in different vertical planes and below the output shaft.

13. The support device of claim 12, wherein the fast gear wheel and the low gear pinion lie on the same rotational axis.

14. The support device of claim 13, wherein the rotational axis of the spindle lies between the rotational axis of the low gear intermediate gear wheel set and the rotational axis of the low gear pinion.

15. The support device of claim 14, wherein the rotational axis of the output shaft, the rotational axis of the low gear intermediate gear wheel set, and the rotational axis of the low gear pinion are arranged parallel to each other.

16. The support device of claim 15, wherein the rotational axis of the low gear intermediate gear wheel set and the rotational axis of the low gear pinion lie in different horizontal planes.

17. The support device of claim 16, wherein the rotational axis of the low gear intermediate gear wheel set lies in a horizontal plane closer to the rotational axis of the output shaft than the rotational axis of the low gear pinion.

18. The support device of claim 17, wherein the low gear pinion is fixed to a pinion coupling part which is supported in a bearing element together with the spindle.

19. The support device of claim 18, wherein there is provided at least one of a driving piece and an input shaft adapted to exert a rotational force onto the low gear pinion by engaging the pinion coupling part.

20. The support device of claim 19, wherein there is provided a foot at a distal end portion of the support inner pipe.

21. The support device of claim 11, wherein the fast gear wheel and the low gear pinion lie on the same rotational axis.

22. The support device of claim 11, wherein a rotational axis of the spindle lies between the rotational axis of the low gear intermediate gear wheel set and the rotational axis of the low gear pinion.

23. The support device of claim 11, wherein the rotational axis of the output shaft, the rotational axis of the low gear intermediate gear wheel set, and the rotational axis of the low gear pinion are arranged parallel to each other.

24. The support device of claim 11, wherein the rotational axis of the low gear intermediate gear wheel set and the rotational axis of the low gear pinion lie in different horizontal planes.

25. The support device of claim 24, wherein the rotational axis of the low gear intermediate gear wheel set lies in a horizontal plane closer to the rotational axis of the output shaft than the rotational axis of the low gear pinion.

26. The support device of claim 11, wherein the low gear pinion is fixed to a pinion coupling part, and wherein the pinion coupling part is supported in a bearing element together with the spindle.

27. The support device of claim 11, wherein there is provided at least one of a driving piece and an input shaft that exerts a rotational force onto the low gear pinion by engaging the pinion coupling part.

28. The support device of claim 11, wherein there is provided a foot at a distal end portion of the support inner pipe.
